(19) United States
(12) Patent Application Publication
(10) Pub. No.: US 2008/0300923 A1
(43) Pub. Date: Dec. 4, 2008

(54) METHOD, SYSTEM, AND INTERFACE FOR SETTING HEALTH INSURANCE PREMIUMS

(76) Inventor: THEODORE J. THEOPHILOS, Westchester, IL (US)

Correspondence Address: PATENT GROUP;C/O DLA PIPER US LLP, 203 N. LASALLE ST., SUITE 1900, CHICAGO, IL, 60601, US

(21) Appl. No.: 12/118,564

(22) Filed: May 9, 2008

Related U.S. Application Data
(60) Provisional application No. 60/932,667, filed on May 31, 2007.

(51) Int. Cl. G06Q 40/00

(52) U.S. Cl. 705/4

(57) ABSTRACT

A method, system, and user interface for adjusting and optimizing health insurance premiums based on an individual's participation in health-related programs.

### CROSS REFERENCE TO RELATED APPLICATION

This application claims the benefit of U.S. Provisional Patent Application Ser. No. 60/932,667, filed May 31, 2007, entitled “Method and System for Adjusting and Risk Rating Health Insurance Premiums,” currently pending which is incorporated herein by reference for all purposes.

### FIELD OF THE INVENTION

The invention relates generally to group health insurance plans and government sponsored health plans (hereinafter referred to as a “plan” or “plans.”) More particularly, the invention relates to a method, system, and user interface for the adjustment and risk rating of an individual's health insurance premiums based upon the insured individual's participation in disease prevention, health promotion, or condition management programs (hereinafter referred to as “health programs.”) The invention further relates to a method, system, and interface for matching an individual's premiums with his participation and adherence to programs related to health behaviors. In addition, the invention relates to a continually-improving predictive model that measures the relationship between incentive dollars and behavior as it pertains to adherence and participation in health programs and uses the data to optimize participation and adherence rates. The invention further relates to optimizing the rate of participation in various health programs, including the capability of creating health programs for corporations that are self-funded. The method and system applies to all forms of health insurance programs, including but not limited to self-insured group health insurance programs, insured group health insurance programs, government health insurance programs (including but not limited to Medicare, Medicaid, and other federal or state employee insurance programs), and individual and association health insurance programs.

### BACKGROUND OF THE INVENTION

The general context of the system and method discussed herein is the Employee Retirement Income Security Act of 1974 (Pub.L. 93-406, 88 Stat. 829, Sep. 2, 1974), commonly known as ERISA. ERISA is a federal statute which, among other things, protects the interests of participants in employee benefit plans and their beneficiaries, by requiring the disclosure and reporting to participants and beneficiaries of financial and other information, by establishing standards of conduct, responsibility, and obligation for fiduciaries of employee benefit plans, and by providing for appropriate remedies and sanctions. ERISA does not require employers to provide any health insurance, but regulates the manner in which such health benefits plans operate.

There have been a number of amendments to ERISA expanding the protections available to health benefit plan participants and beneficiaries. One important amendment, the Health Insurance Portability and Accountability Act of 1996, or HIPAA, allows employees to obtain continued coverage for preexisting medical conditions in some circumstances when they move from one plan to another and prohibits discrimination in health coverage based on factors that relate to an individual's health. Such health factors include a vast array of conditions and risks, including by way of example without limitation high blood pressure, obesity, failing to treat or remedy hypertension, hypercholesterolemia, stress, sedentariness, tobacco use and over consumption of food.

HIPAA specifically prohibits the implementation of a group health insurance plan, government sponsored health plan or other health insurance program in which a premium for an individual member of the plan or program is set based on her individual health factors. For instance, on Dec. 13, 2006, the United States Department of Labor, Treasury, and Health and Human Services issued final HIPAA nondiscrimination and final wellness regulations. See 71 Fed. Reg. 75014, which is incorporated by reference. These rules, which are applicable to group health plans for plan years beginning in July 2007, do not allow discrimination in adjusting premiums based on health factors. However, HIPAA does allow plans that adjust premiums based solely on participation in a health promotion program—“the HIPAA nondiscrimination provisions do not prevent a plan or issuer from establishing discounts or rebates or modifying otherwise applicable co-payments or deductibles in return for adherence to programs of health promotion and disease prevention. 71 Fed. Reg. 75017.

Under this regulatory regime, individual members of healthcare plans do not pay the full costs of their decisions about health style choices and health risk activities that impact health. As a consequence of the prohibition against risk rating of individual's premiums to individual's health risk, there exists a systematical shielding of those who engage in certain life style choices, such as failing to treat or remedy hypertension, hypercholesterolemia, excessive stress, sedentariness, tobacco use or over consumption of food, from paying a more accurate cost for usage of the health resources. Accordingly, substantial negative externalities are imposed upon the group healthcare plan or program, and thus on the other participants, by those who elect certain life style choices that enhance the risk of need for future complex medical interventions.

There are nonetheless salutary aspects with respect to this regulatory regime, which prohibits underwriting an individual's premium to their respective individual risk. For example, it accommodates the provision of group health coverage to individuals who have an extraordinary likelihood of consuming substantial medical resources for complex medical interventions, such as a person with congenital disease or conditions of a protracted or complicated nature. That being said, it is estimated that approximately 75% of the $2.2 trillion spent in the United States for health care are expended for diseases or conditions that were preventable, could have been postponed, or whose severity could have been ameliorated if certain lifestyle changes pertaining to certain, risk factors would have been adopted by the individual group health plan member.

A further consequence of the prohibition against underwriting premiums based on health factors is that behavior adverse to the overall amount of health care resources that are or will be consumed is shielded from bearing the full economic costs derived from that behavior and thereby increasing the amount and severity of the adverse behavior. Having shielded the individual from the full cost of their adverse behavior, that behavior is unabated and costs for the entire group health care plan increase. Individuals who are healthy or those that do not engage in life style choices adverse to the economic interests of the group plan are disincented to remain members of the plan and either drop plan membership to select other forms of health insurance or obtain no insurance at all, creating a vicious circle in which the costs for the remaining participants continue to increase and the ranks of uninsured in the United States swells.

Therefore, it would be desirable to have a method and system, and an associated user interface, that not only risk rates a group healthcare plan member's premium based upon legally permissible principles, which, as discussed above, includes participation in certain programs, but which also does not have the effect of raising the costs for all plan members, including those who elect to adopt lifestyle choices favorable to plan economic interests. It would be further desirable to have a method and system that adjusts the risk rating over a period of time to optimize participation in and adherence with individual life choices, disease prevention, health promotion and condition management decisions, which reduce the risk of the need to expend medical resources for complex medical interventions and that further allows for the rating to be adjusted for programs that have the maximum positive impact on ultimate health outcomes over time. It further would be desirable to have a method and system for optimizing the rate of participation in various disease prevention, health promotion and condition management programs.

It further would be desirable to have a system and method to provide an interface for use by professionals involved with providing health care insurance to companies, to provide for an efficient and user-friendly process.

The foregoing examples of related art and limitations associated therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools, and methods that are meant to be exemplary and illustrative, not limiting in scope. In various embodiments, one or more of the problems described above in the Background have been reduced or eliminated, while other embodiments are directed to other problems.

An exemplary system, method, and interface according to an embodiment of a system and method that matches individuals' premiums with their participation in and adherence with health programs and optimizes the rates of participation in and adherence with these programs is described. Broadly stated, the system, method, and interface involve determining the total cost of providing health care for a group health population adjusted with an accrual for the discounted present value of the future cost of medical interventions for certain specified health conditions, illnesses and diseases, allocating the total cost of the health plan, in whole or part, to its member participants, periodically adjusting the individuals' premiums based upon their participation in and adherence with health programs created to lower the risks of those certain specified conditions, illnesses and diseases, and finally periodically optimizing the participation in and adherence with these programs by adjusting the premiums based upon health status, claims information and/or participation and adherence data. The system, method, and interface may include the ability to allow a participant's adjustment to contributions to be impacted by their participation in and adherence in programs over time so that sustained participation and adherence is incented by these adjustments to premiums or contributions.

According to one aspect of an embodiment of the present invention, individual premiums will be matched by a decrease in risk based upon an individual's participation in and adherence with certain health programs. An initial set of targeted health risks are established and an accrual for the discounted present value for those health risks is determined. Adjustments are made to an individual's premium based upon the particular health risk involved as well as the individual's participation in and adherence with certain programs designed to ameliorate the risk associated with the specific health condition, disease or illness.

According to another aspect of an embodiment of the present invention, premiums will be adjusted by a process that optimizes the rates of participation in and adherence with certain disease prevention, health promotion and condition management programs by tracking over time the health status, medical claims and participation and adherence information as well as the changing assessment of the risk associated with a particular health condition compared to other health conditions related to the group health plan members.

According to another aspect of an embodiment of the present invention, the optimization of the rate of participation in health programs, including optimization to the point of creating health programs that are self-funded, is accomplished by assigning a participation and adherence rate composite index (hereinafter referred to as “index”) based on a company's unique demographics and census characteristics and the selection of health programs that the company makes.

In addition to the exemplary embodiments and aspects described above, further embodiments and aspects will become apparent from the accompanying drawings and from the detailed description which follows.

### BRIEF DESCRIPTION OF THE DRAWINGS

Exemplary embodiments are illustrated in referenced figures of the drawings. It is intended that the embodiments and figures disclosed herein are to be considered illustrative rather than restrictive. The present invention is illustrated by way of example and not by way of limitation, in the figures of the accompanying drawings and in which like reference numerals refer to similar elements and in which:

FIG. 1 shows an embodiment of the method discussed herein.

FIGS. 2A-2F show an example of indexes calculated according to an embodiment of the present inventions.

FIG. 3 and FIG. 4 show embodiments of aspects of the system discussed herein.

FIGS. 5A-5K show various embodiments of the user interface discussed herein.

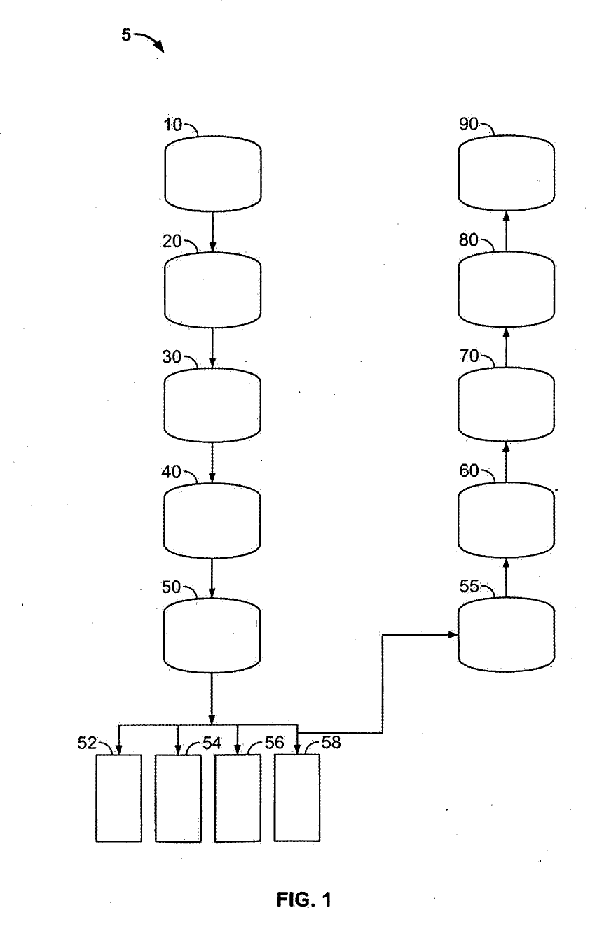

### DETAILED DESCRIPTION

The method, system, and interface described below, with illustrative but not limiting examples, all aid in establishing health insurance premiums or member contribution amounts based upon participation in disease, prevention, health promotion and condition management programs for the purpose of achieving health plan cost reductions and improvements to the health status of plan or program participants. They also may be used to optimize the premiums to maximize participation in health programs. The method, system, and interface have been, are presently being, and will in the future be referred to by the trademarks by EngagementHealth LLC: Participatory Underwriting™, Participatory Underwriting Design System™, The Engagement Health Participatory Underwriting Design System™, EngagementHealth™, and Making the Habit of Adherence the Heart of Good Health™.

Turning first to Figure One, the general method of an embodiment of the invention is shown at 5. First, the number of individuals who are enrolled and eligible to participate in the group health plan or program is determined, at 10. This may be done, for example, by determining the historical plan enrollment rate for the particular company, determining an estimated percentage enrollment rate, by determining a regional industry enrollment rate of those who are eligible to participate in the group health plan or program, or by determining the number of those who have enrolled in the plan or program. This determination is forward-looking and, for example, can be an estimated percentage based on either company specific historical information or industry/regional historical information.

Next, at 20, the total annual cost of the plan (“TAC”) for the next plan year is determined using standard actuarial procedures that are well known, or estimated based upon the historical costs of the plan or program. Included in the total annual cost of the plan could be all categories of expenses set forth in the plan's descriptive documents, such as fees from doctors, pharmacies, and hospitals, and all other areas of services, and cost covered by the plan or program. In addition, all administrative service fees from third parties or the plan sponsor may be included in the total annual cost of the plan. Any suitable costs for a particular plan can be included.

Next, at 30, an allocation reflecting an accrual for the discounted present value of future costs (“DPVFC”) for the plan regarding to certain diseases, conditions, risks or treatments can be determined. This accrual is made after reviewing the census data and demo graphics of the group plan members, making an assessment either based on group historical medical information or based upon more general population health statistical information, factoring in the turnover of the group membership based on actual historical information or based on broader related industry or geographic data and factoring the costs of treatments for various conditions adjusted for time and regional cost differences. The future estimated costs for the group of those eligible to participant in the plan for various single or combined diseases, conditions, or risks are determined using standard, well known actuarial techniques. The accrual of the discounted present value of the future costs for the various diseases, including for single or combined diseases, conditions, and risks is determined. It should be noted that the step of performing this accrual need not be done to carry out the method of the embodiment of the invention disclosed but it is preferable to do so.

Next, at 40, this allocated amount is added to the total annual cost of the plan to determine the adjusted total annual cost of the plan (“ATAC.”) The cost of the plan can be allocated on a per employee, per adult participant, per other eligible participant basis, or any other acceptable basis.

Next, at 50, the employee or participant population, if desired, is divided into multiple tiers, in any suitable manner of dividing the population. For example, in the non-limiting embodiment described here, the population is divided into four tiers. The first tier 52 consists of members who have enrolled in the health plan or program electing to have plan coverage only for themselves, the members only tier (“MOT”.) The second tier 54 consists of members who have enrolled in the health plan or program electing to have plan coverage for themselves and their spouse, domestic partner or another adult covered person (as determined by the terms of the plan or program), the members and spouse tier (“MAS”.) The third tier 56 consists of members who have enrolled in the health plan or program electing to have plan coverage for themselves and their non adult covered dependents, or members and children (“MAC.”) The fourth tier 58 consists of members who have enrolled in the health plan or program electing to have plan coverage for themselves, their spouse, domestic partner or another adult covered person (as determined by the terms of the plan or program) and their non adult covered dependents, or members and spouse and children (“MSC.”)

Next, at 55, if desired, the tiers are further divided into wage bands based on gross income or other suitable criteria.

Next, at 60, each tier is allocated a portion of the adjusted total annual cost or, if the accrual of step 30 has not been made, the total annual cost, is expressed as a percentage of the per employee cost or per eligible participant cost. This allocation is computed based upon suitable market considerations, which can include both regional and/or industry data. For each employee or eligible participant a cost is allocated expressed as a percentage of the group cost for the group that the employee or eligible participant has enrolled. The manner in which the tiers are allocated costs is subject to many different options, including the historical medical claims data for the particular tier or more general data for medical claims associated with the individuals who would be segmented into tiers such as are described above.

Next, at 70, the health programs and the costs associated with those health programs, which adult plan participants are given the opportunity to participate in and adhere to, are established. These health programs could include, but are not limited to, programs to decrease or manage hypertension, hypercholesterolemia, diabetes, asthma, arthritis, excessive stress, obesity, weight, exercise or any manner of risk activity or conditions that have an impact on health status. A dollar value is assigned to each health program per adult participant. For example, each adult participant's wage banded contribution rate in the selected tier, expressed as a percentage of the plan or program per employee or eligible participant cost, could be adjusted based upon their respective participation in and over the course of the plan year, their adherence with, the disease prevention, health promotion or condition management programs in which they enrolled, if any. These are, in essence, deductions from the individual's health premiums for that year, but could be in the form of other economic incentives.

Next, ATAC or TAC, depending on which is applicable, is allocated across all adult participants in the plan including adjusted dollar values for each program resulting in the final annual cost of the program (“FAC”) at 80.

Finally, at 90, the premiums are set based on the ATAC or TAC as applicable, the employee's assigned tier, whether or not wage banding is selected, and, whether or not the employee and or adult dependent elects to participate on one or more of the health programs that are offered.

A further aspect of the health programs that are set according to an embodiment of the present invention is that they may be set in such a manner that they become self-funded, that is, there is no cost to the company for offering, implementing, and executing the health programs. The following non-illustrative example describes this, in the context of employer offering a self-insured medical benefits program, which the employer desires to implement such that it includes self-funded health programs. This example also illustrates an illustrative example of other aspects of the present invention, including those described above.

The administration of a company's health care program will be described below with a specific example, for the fictional Apollo Company, which is not limiting but rather is illustrative. For the purposes of explanation, numerous specific details are set forth in order to provide a thorough understanding of the present invention. It will be apparent, however, to one skilled in the art that that the present invention may be practiced without some of these specific details. Moreover, this illustration is intended to be illustrative and not limiting of the invention.

The number of employees eligible for membership in a group health plan is determined from payroll information for the fictional Apollo Company, for use in the 2008 Apollo Plan. This example is based on setting premiums for year 2008, and is therefore carried out in 2007.

Based upon a review of the payroll information from year 2006, the eligible pool for 2008 enrollment for Apollo Company is 100,000 benefits eligible adult participants.

This number is then multiplied by the enrollment rate of those employees eligible to be members of the group healthcare plan, determined from historical enrollment rates or related industry enrollment rates. In this case historical enrollment rates for years 2000-2006 for Apollo determine an enrollment rate of 80 percent.

Next, TAC is determined using customary actuarial techniques or estimates based on historical information. TAC for Apollo for 2008 is $500 million.

Next, using well-known standard actuarial techniques based upon past data for Apollo Company (and other similar companies or groups of individuals) the DPVFC of the future claims generated for treatment related to certain and various health conditions, diseases and illnesses is calculated. In this case DPVFC is calculated to be $20,000,000. Again, it is not necessary to carry out this accrual to practice the disclosed method.

If the accrual step is chosen to be done, an adjustment is made to the TAC to include this discounted present value. In this case ATAC is $520,000,000.

TAC or ATAC, as applicable, is then allocated in the form of contribution requirements among the group's adult participants in the group healthcare plan, by dividing the pool into four tiers.

In this case MOT comprises 20,000 employees, MAS comprises 30,000 employees, MAC comprises 10,000 employees, and MSC comprises 20,000 employees.

The four member tiers are then further each segmented into bands based upon the compensation earned by the member so that a more highly compensated member pays a greater plan premium or contribution. This segmentation is based upon the marginal tax rate into which a member might fall based upon that compensation information.

For Apollo, the first wage band consists of plan members who have adjusted gross income or compensation which is $30,650 or less, or such other number as may be determined. To this wage band a multiplier of 1.00 or such other suitable number is applied. For example, an adjustment can be made to the cost allocated to each employee or eligible participant based upon their “adjusted gross income” as defined by the Internal Revenue Service expressed as a percentage based off of the lowest then existing marginal tax rate. The second wage band consists of plan members who have adjusted gross income or compensation which is greater than $30,650 but less than $74,200, or such other number as may be determined. To this wage band a multiplier of 1.10 or such other suitable number is applied. The third wage band consists of plan members who have adjusted gross income or compensation which is greater than $74,200 but less than $154,800, or such other number as may be determined. To this wage band a multiplier of 1.13 or such other suitable number is applied. The fourth wage band consists of plan members who have adjusted gross income or compensation which is greater then $154,800, but less than $336,550 or such other number as may be determined. To this wage band a multiplier of 1.18 or such other suitable number is applied. The fifth wage band consists of plan members who have adjusted gross income or compensation which is greater then $336,550, or such other number as may be determined. To this wage band a multiplier of 1.20 or such other suitable number is applied. These bands are designated A-E.

Next, each tier is allocated a portion of TAC or ATAC, as applicable, the portion expressed as a percentage of the per employee cost or per eligible participant cost. This allocation is computed based upon market considerations, which can include both regional and/or industry data, as well as recruitment, retention, and employee reductions considerations. For each employee or eligible participant a cost is allocated expressed as a percentage of the group cost for the group that the employee or eligible participant has enrolled. The manner in which the tiers are allocated costs is subject to many different options, including the historical medical claims data for the particular tier or more general data for medical claims associated with the individuals who would be segmented into tiers such as are described above.

Here by way of illustration, the ATAC is allocated among all adult participants, based on whether they are in wage band A-E and whether they are in MOT, MAS, MAC or MSC tiers, what costs are determined for each health program (see below), what programs an adult participant elects to participant in and ultimately over the plan year with what programs an adult participant complies. As an example, an adult participant in wage band A and in the MOT tier, who participated and complied with both the CPP and a TaRP (see below) would contribute her allocated portion of the ATAC adjusted by the MOT calculation multiplied by 1.00. If an adult participates in wage band A and in the MOT declined to participate in the CPP and TaRP, that member would contribute her allocated portion of the ATAC adjusted by the MOT calculation multiplied by 1.00 plus the PC associated with the CPP and largest PC for a TaRP.

Disease prevention, health promotion and condition management programs are established for the group healthcare plan members and other covered adults. For each health program, an annual dollar value is assigned based upon anticipated participation and adherence rates in the program as well as the relative risk that the particular risk, disease or condition presents to the group that year. A member who participates in and complies with provisions of the program earns the dollar value assigned to each program and can apply the earned amount towards a premium payment of contribution to the plan.

For the 2008 Apollo Plan, the following programs are offered, with the respective dollar values listed for completion of the program.

The first is the “Tobacco Free” Program, which is, essentially, a declaration that, in consideration for a dollar incentive, an employee or adult dependent pledges to remain tobacco free for the upcoming twelve month period, or participate in a tobacco cessation program. The second health program is the “Core Prevention Plan” (“CPP”). This health program is a program in which the employee and/or dependents agree to participate in a series of disease prevention activities, including health screening, completing a health risk assessment, and periodic calls with a health professional to discuss individual health risk characteristics. The third program is the “Targeted Risk” or “TaRP” program. In this health program, the employee or adult dependent elects one of six programs addressing an individual health risk, including hypertension, dislipdemia, sedentary risk, weight management, tobacco cessation, and stress management.

For each program, an annual dollar value is assigned based upon anticipated participation and adherence rates in the program, as well as the relative risk that the particular disease or condition presents to the group that year. A member who participates and adheres with the provisions of the health program earns the dollar value assigned to each program and can apply the earned amount towards a premium payment of contribution to the plan. In this example, the Core Prevention Plan is associated with a $200 annual incentive. The TaRP would have participating incentives set at $600 per adult participant. The Tobacco Free Program's incentive is $400 per adult participant.

Any other suitable programs and costs could be part of the Apollo Plan.

Next, based upon Apollo's inputs and selections based on the demographics of the company, an index range (with a high end and a low end) is calculated. This may be calculated using any suitable algorithm. For example, EngagementHealth LLC currently uses algorithms that match anticipated rates of participation and adherence to each individual health program and the dollar incentive associated with each individual health program. The algorithms can be adjusted to account for various factors, including employment status, age, and income. The index is calculated by determining the total cost of the health programs selected and subtracting program components from that amount, which are selected by the employer, including offering any particular program and selecting further refinements, including wage banding.

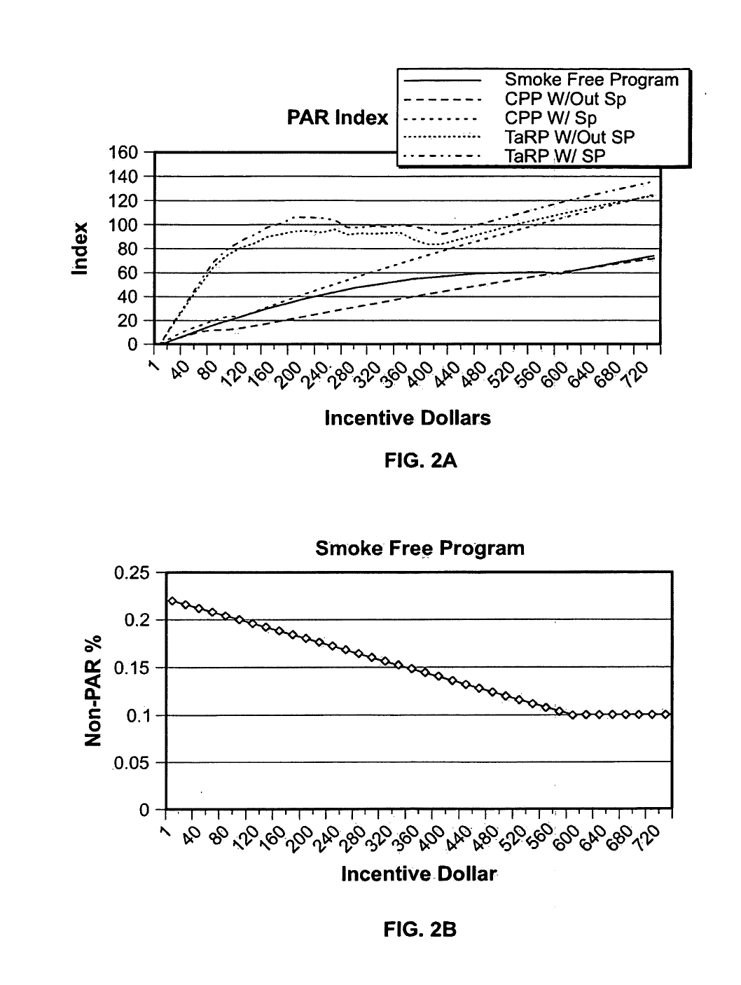

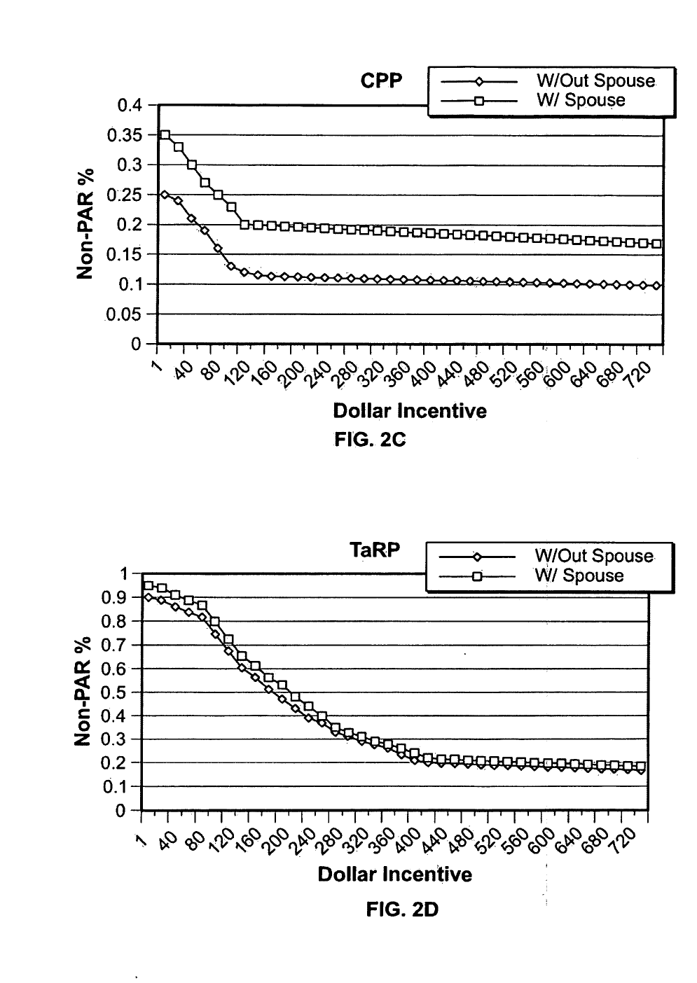

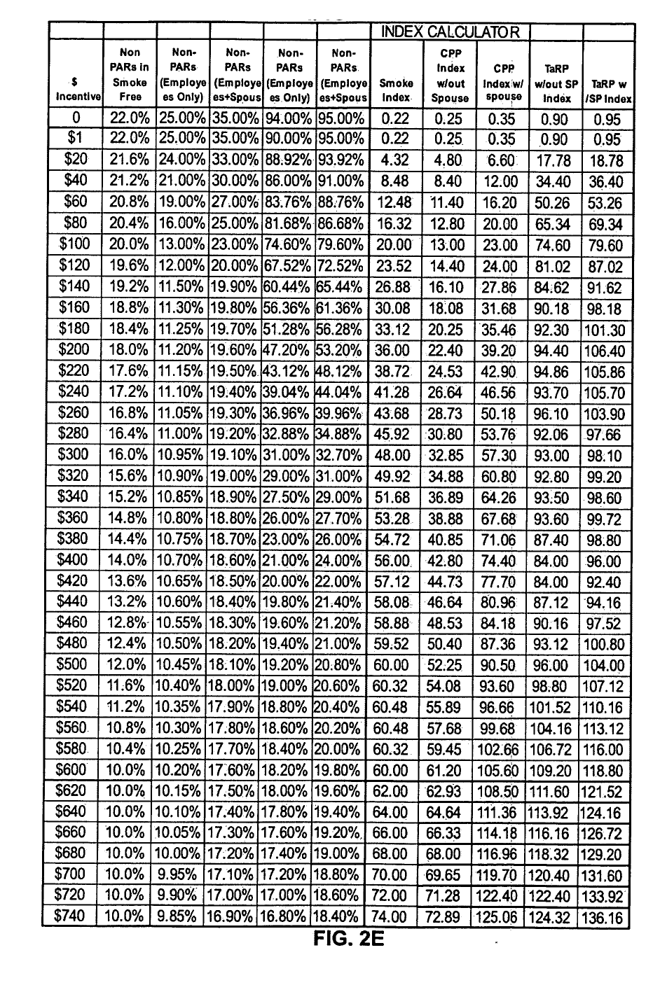

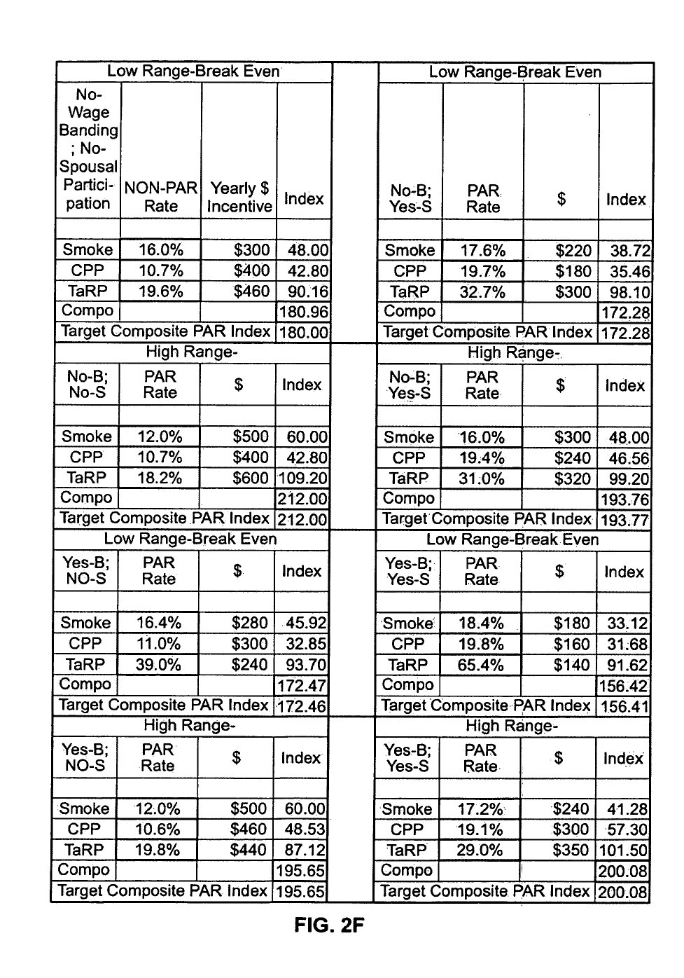

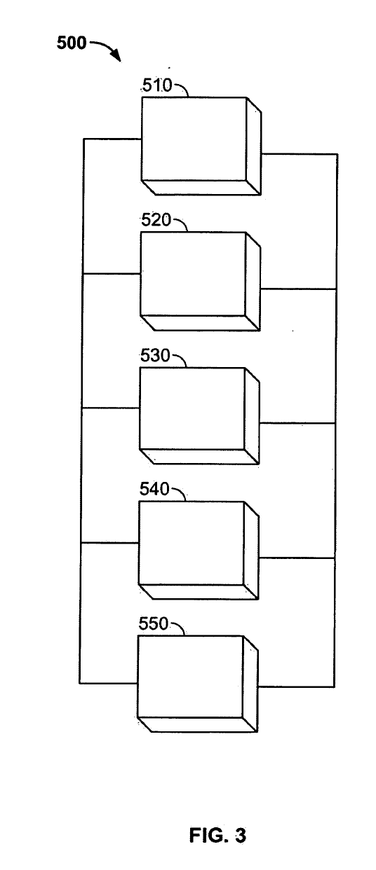

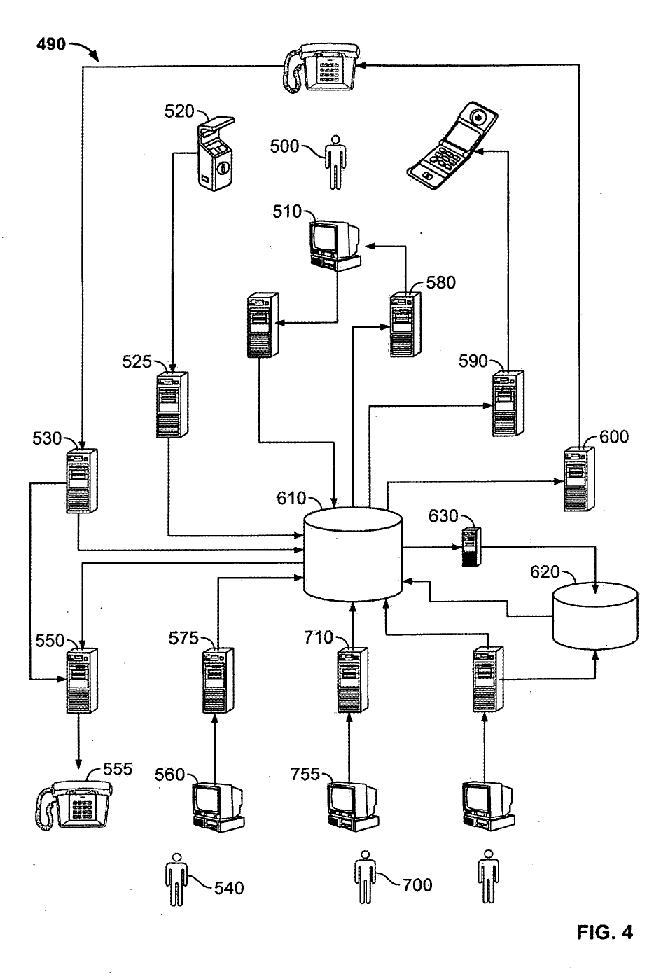

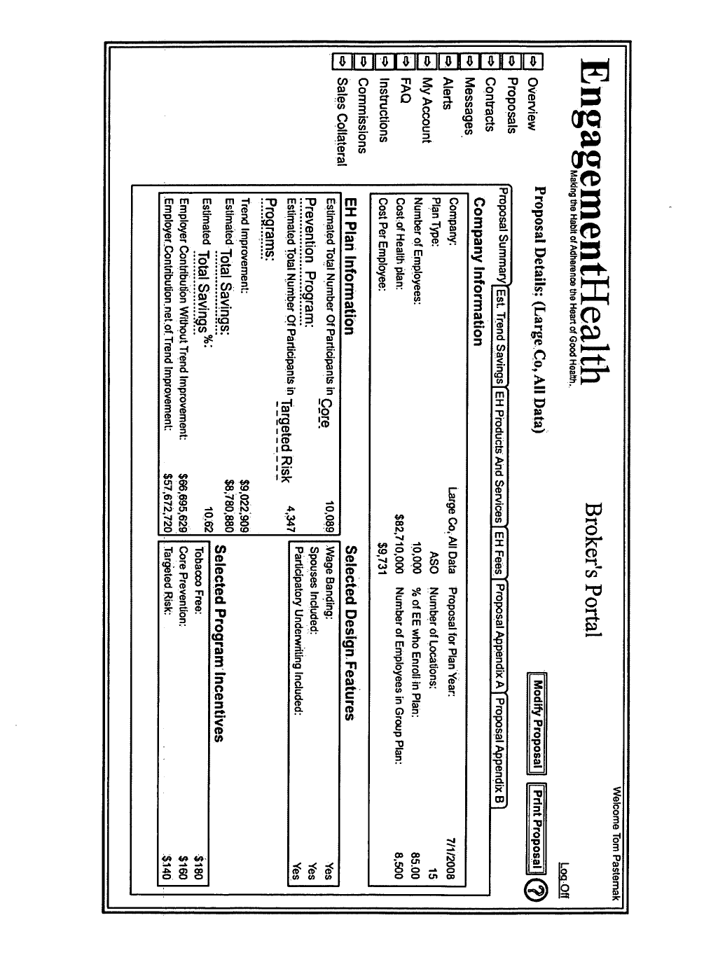

In the case of Apollo, the calculated index, based upon all of the selections discussed above and carrying out the appropriate algorithms, is shown in FIGS. 2A-2F.

Next, a predictive model analyzing a dose response determines the forecasted rate of participation in, and adherence to, (or non participation and non adherence) the various health programs. See Figure Two also shown for the predicted rates of participation for Apollo. The participant population is thereby segmented into multiple categories based on participation and adherence in whole or in part with programs and the consequent adjustment in participant contributions that is based on that participation and adherence.

More specifically, based upon the index ranges, the employer can select the actual incentive amounts that it desires to pay for the health programs that are in its plan. As long as the incentive amounts are set so that they are not less than or equal to the low end of the range and not greater than or equal to the high end of the range, the health programs will be self funded.

With these incentive amounts in place, the method of the embodiment is carried out as described above.

Additionally, if desired, the predictive, model that is used can be continually improved. Periodically, and at least annually, the algorithms which support the invention can be revised with the results of the relationship between actual incentive levels and actual participation and adherence levels. For example, the experiences regarding participation and adherence levels at a particular company, accounting for its unique characteristics with respect to population age, gender, income level, the nature of the industry, and other factors, associated with actual established incentive amounts, will be tabulated and computed. These findings will adjust the algorithms which support the inventions.

This aspect of the inventions disclosed herein allows for the implementation of health programs that are self funded by the plan itself. The funding for the health programs is derived from the incremental difference between what a fully-participating and fully-adhering member would pay for her contributions to the plan versus what a non-participating and non-adhering, in whole or in part, member would pay for her contributions to the plan. This creates the manner of establishing an actuarial model that balances the essential interests of the plan with the legally-protected rights of plan members. The social utility of the inventions disclosed herein is greatly enhanced because it creates a funding mechanism, which eliminates the impediment to broad implementation of health programs.

According to another aspect of the inventions disclosed herein, participation and adherence rates may be optimized on an ongoing basis, if desired. One methodology for performing this optimization calculation is as follows, although any suitable methodology may be used, and this method is only illustrative as one embodiment.

X=the total number of plan members who participate and complete programs

X=X¹+X² . . . +Xⁿ

X¹=number of plan members who participate and complete a particular program (Program 1)

On a periodic basis, such as annually, semi-annually, quarterly, or any other suitable period, the health status of all plan members who participated and completed to date a particular program is evaluated based upon medical examination data and periodical health risk assessments, questionnaires and a general adherence review. Each program is given a total cumulative score based on the health status improvements in the particular program.

For example, this evaluation may be done as follows.

A=the total health status improvements for all programs

A=A¹+A²+ . . . Aⁿ

A¹=the total health status improvements for a particular program (Program 1)

Next, once X and A have been calculated, the following calculations are performed.

X¹/X=a₁% of X

X²/X=a₂% of X

Xⁿ/X=aₙ% of X

A¹×a₁×100=B¹

A²×a₂×100=B²

Aⁿ×aₙ×100=Bⁿ

Bⁿ=The adjusted health status improvement score for a particular program

B¹=the adjusted health status improvement score for Program One

B=B¹+B²+ . . . Bⁿ

Accordingly, the dollar value that is assigned to each program is adjusted on a periodic basis by the relationship between B¹ to . . . Bⁿ.

According to yet another aspect of the inventions disclosed herein, the invention allows for the establishment of a unique incentive based upon the criticality of a particular health program in relation to the health characteristics, census data, and demographics of a particular participant population or plan. For example, if a company had an employee population which presented itself with a significant risk of hypertension, a unique incentive could be created so that the participation and adherence to a health program directed to remediate the risk of hypertension could be established, such as by increasing the participating employee's contribution by a greater amount than the contribution of employees either not participating or participating in other health programs.

Turning next to Figure Three, further aspects of the method and system discussed herein are shown. Various data sets 500 can be utilized in carrying out the method. For example, here health care data sets 510 are created and stored in a computer system (one embodiment of an applicable computer system is described below) for each adult participant in the group healthcare plan, including individual health status information, participation data, adherence data and/or health claims data. Health status data 520 including the results of periodic responses to the questionnaires answered by adult participants is stored in the system as well.

Data with respect to the specific health programs into which each adult participant enrolled 530, as well as health claims data 540 for each adult participant is also stored in the computer system. Data with respect to each adult participant's adherence with a program 550 is also stored in the computer system as a participant completes a particular program. Other data may also be stored and utilized as is desirable. All data used in the method may also be accessed from other databases, either internal to the company or organization at issue or kept in an out-sourced location. The descriptions herein about locations and types of data used are meant to be illustrative and not limiting.

Based upon these data sets, on an annual or other periodic basis, as is desired, the dollar value which is assigned to each disease prevention, health promotion or condition management program is adjusted to optimize participation. The optimal dollar value assigned to each disease prevention, health promotion and condition management program is periodically reevaluated to maximize the participation rate, adherence rate and health status outcomes of the adult participants.

Adherence with the programs is assessed by adherence administrators who monitor and rate the adherence of members and other covered adult participants. The adherence administrators implement a qualitative adherence scoring system incorporating member and adult participant consultation information as well as claims information and the results of questionnaires to members and adult participants. The dollar value assigned to the various disease prevention, health promotion and condition management programs are systematically adjusted annual or periodically based upon the participation rates of the plans, the adherence scoring and the relative risk posed by the particular disease, risk or condition to the group.

For example, for the Apollo 2008 Program, during year 2008 adherence administrators would monitor the adherence of members via the internet using a adherence website as well as a distributed network of kiosks, a network of medical measurement devices which are uploadable to the website, as well as email and instant message and paired or group telephonic communication. Any other suitable method or system may be used. If a participant fails to participate in or comply with the program or programs, the incentive contribution reduction is stopped and the individual will have the opportunity to participate in a program or program the next plan year at the same or different incentive rate. It should be noted that adherence for the year of registration is assumed.

As part of the this embodiment data sets are created and stored in the computer system (one embodiment of a computer system for practicing the system and method described here is described below) for each adult participant in the group healthcare plan, including individual health status information, participation data, adherence data and/or health claims data. Health status information including the results of periodic responses to the questionnaires answered by adult participants is stored in the system as well. For the Apollo 2008 Plan, the following data sets are created annually—participant data sets for body mass index (“BMI”), blood pressure, HDL, LDL, blood glucose, urinalysis, mammogram, and colorectal screening. Weekly, monthly or quarterly or semi-annual data sets for these parameters are taken. These are illustrative examples.

For Apollo, claim data is entered into the system as claims are made.

Data with respect to the specific programs into which an adult participant enrolled is also stored in the computer system. Data with respect to each adult participant's adherence with a program is stored in the computer system as a participant completes a particular program. Health claims data for each adult participant is also stored in the computer system or accessed from other databases, when such claims are made. In this case, for the Apollo 2008 Plan, upon completion of each program a adherence score is assigned to each participant and the adherence scores are aggregated by program groups and compared to other individual scores and other program groups.

Turning to Figure Four, a further embodiment of aspects of the present invention are shown in the context of an illustrative Participatory Underwriting System 490.

Members 500 register using a web browser 510 connecting to the system. After registering, they use the system to determine the steps needed to complete the program successfully and to review their health information. Members that have access to a kiosk 520 at their work location or have access to a retail kiosk, which can access the system via to kiosk server 525, will use them once a week to update their health information, or at any other suitable interval. Members who do not have access to a kiosk may use an interactive voice response (IVR) system 530 to update their health information. Members may also use the IVR system to call and get connected to a counselor 540, to consult with their counsel about their health programs. A Call Control 550 is used to determine which member needs to talk to which counselor, via phone 555 or any other suitable communication channel. Adherence Counselors use web browser 560 to connect via adherence monitoring server 570 to review the health status and adherence level of members.

Outgoing, e-mail server 580, SMS server 590, and voicemail server 600 are used to send emails, text messages and voicemails respectively to members, to remind them of upcoming events such as calls, health screens or weekly monitoring. They also are used to send the members notifications if they miss steps in their program.

All of the information entered by the members and adherence counselors are maintained in the transactional database 610. Further, the rules that govern the design of health programs and member incentives are stored in parametric database 620. These rules are initially set based on information collected from external sources. Over time the parameter optimizer 630 will use the data collected in the transactional database 610 to enhance and improve the rules and parameters in the parametric database.

Brokers 700 can use via broker portal server 710 via web browser 715 to create proposals for prospective customers. The proposals are created in the transactional database based on information from the parametric database to help prospective customers determine the final structure of the programs that would like their employees to enroll in.

Based upon these data sets, the computer systematically adjusts on an annual or other suitable periodic basis, the dollar value which is assigned to each disease prevention, health promotion or condition management program. The system determines the optimal dollar value assigned to each disease prevention, health promotion and condition management program to maximize the participation rate, adherence rate and health status outcomes of the adult participants.

For example, at the end of the plan period of such other time appropriate in advance of the next plan year, the health status, outcome of all participants in the CPP and the TaRP is calculated and determined. For illustration purposes, 25,000 adult participants completed TaRP 1, 15,000 adult participants completed TaRP 2 and 10,000 adult participants completed TaRP 3. For this illustration, 20,000 individuals in TaRP 1 experienced health status improvements, 10,000 individuals in TaRP 2 experienced health status improvements and 5,000 individuals in TaRP 3 experienced health status improvements. For this illustration, those adult participants who completed TaRP 1 had adjusted health improvement scores based on program coordinators adherence assessments of 15,000, those adult participants who completed TaRP 2 had adjusted health improvement scores based on program coordinators adherence assessments of 10,000, and those adult participants who completed TaRP 3 had adjusted health improvement scores based on program coordinators adherence assessments of 1,000. B=The adjusted health status improvement score for a particular program was 26,000. B¹+the adjusted health status improvement score, for Program One. B=B¹+B²+ . . . B³. X=the total number of plan members who participate and complete programs was 50,000. X=X¹+X²+X³. X¹=number of plan members who participate and complete a particular program (TaRP 1). A=the total health status improvements for all programs was 35,000. A=A¹+A²+A³. With the determination of X and A, the following calculations are performed to derive B. X¹/X=a₁% of X. X²/X=a₂% of X. X³/X=a³% of X. A¹×a₁×100=B¹. A²×a₂×100=B². Aⁿ×a³×100=B³. Accordingly, the dollar value that is assigned to each program is adjusted on a periodic basis by the relationship between B¹ to . . . B³.

The method and system adjust on an annual or periodic basis to more greatly incent participation into the programs with the greatest health improvement scores and adherence rate the prior period. In the case of Apollo, to the extent that a particular supplemental program generated a greater health improvement or adherence score, the incentive associated with that program for the next plan period would be increased by a factor derived by the relationship to the health improvement scores and adherence scores for all of the other programs. This would result in the programs which generated the greatest health improvement in the prior period having the highest incentives in the next plan years. However, to the extent that the greater incentive increased participation but lowered adherence in the subsequent period the program would again adjust to lower the incentive associated with the program and thereby would find the optimal rate of incentive to maximize participation as well as adherence.

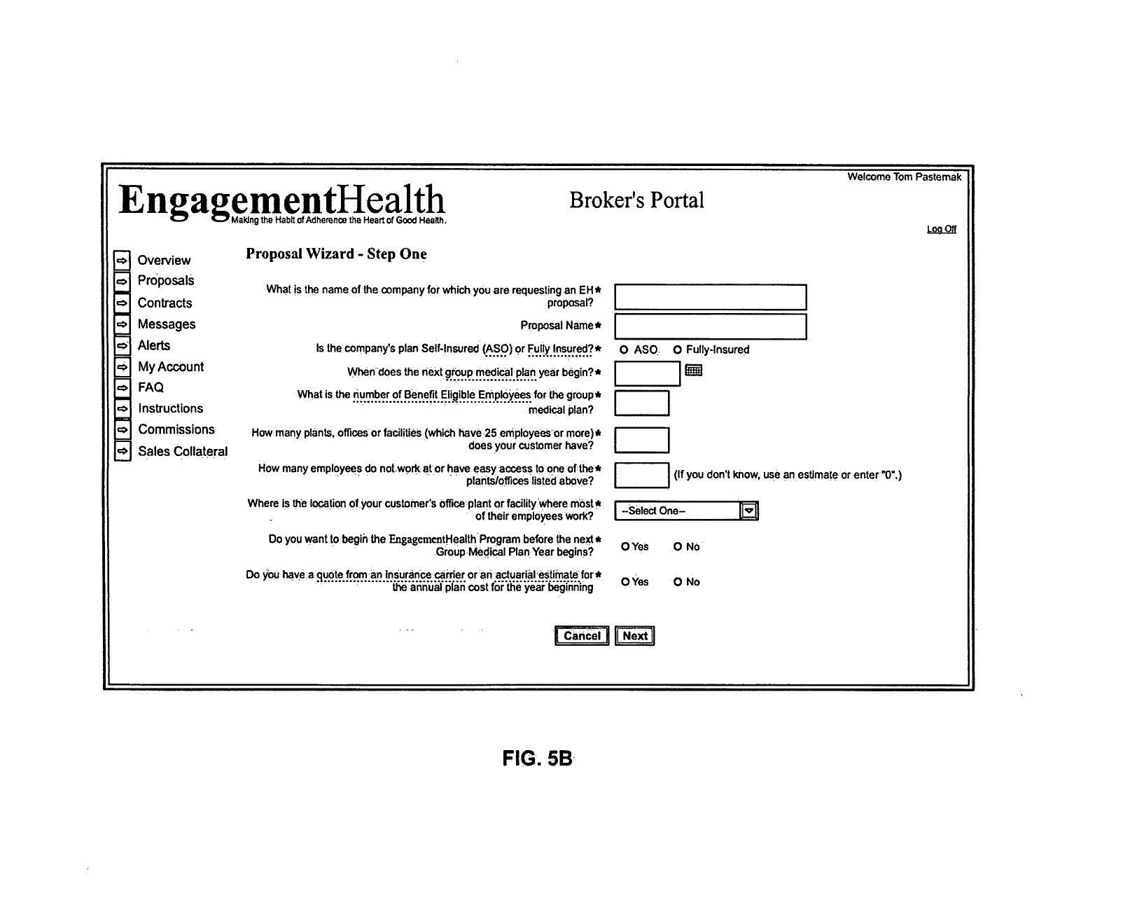

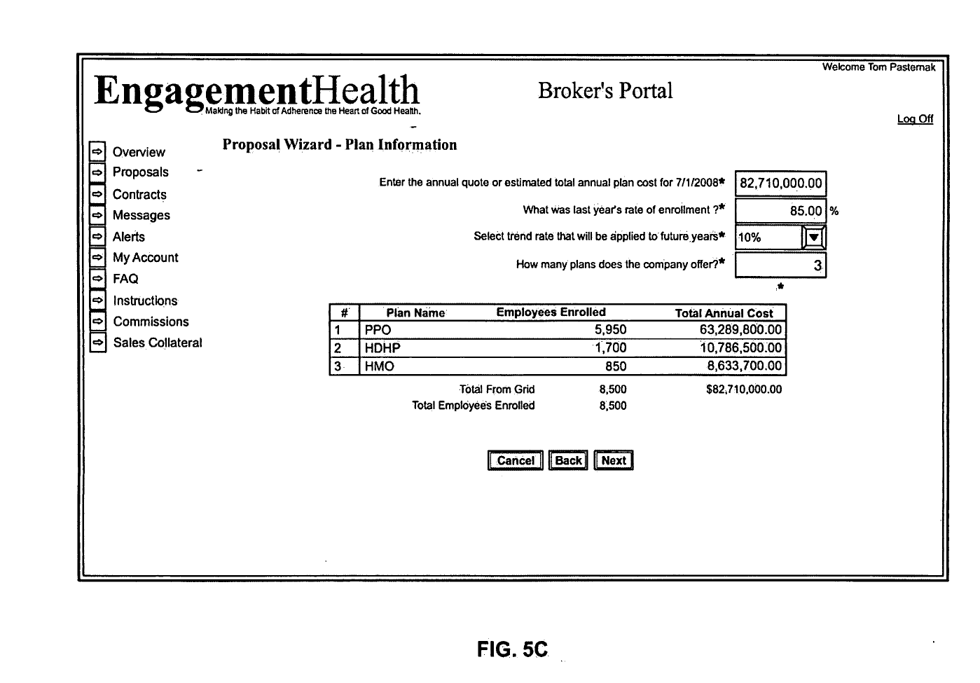

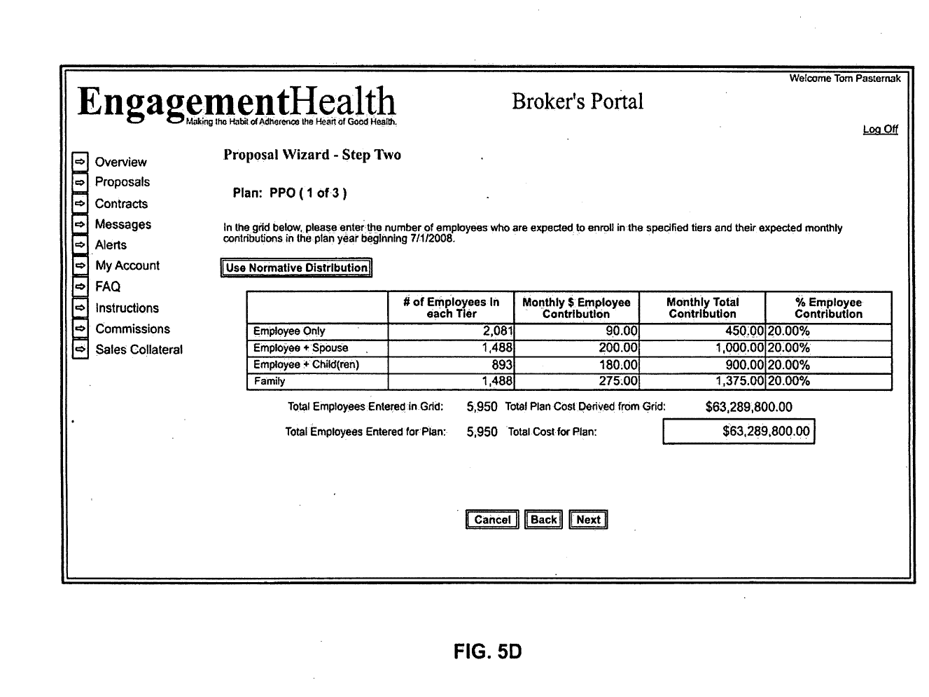

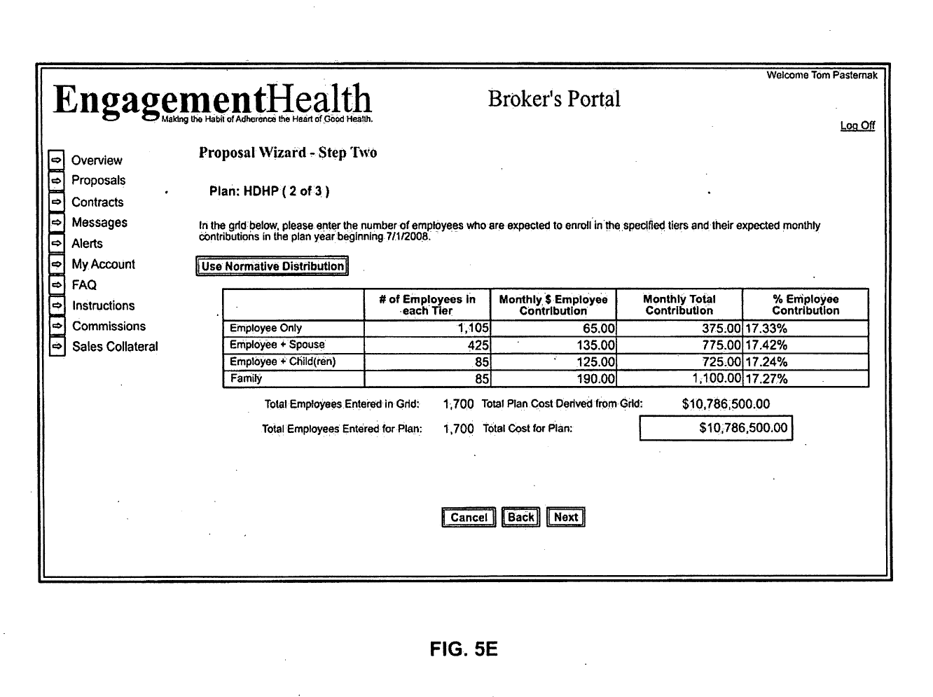

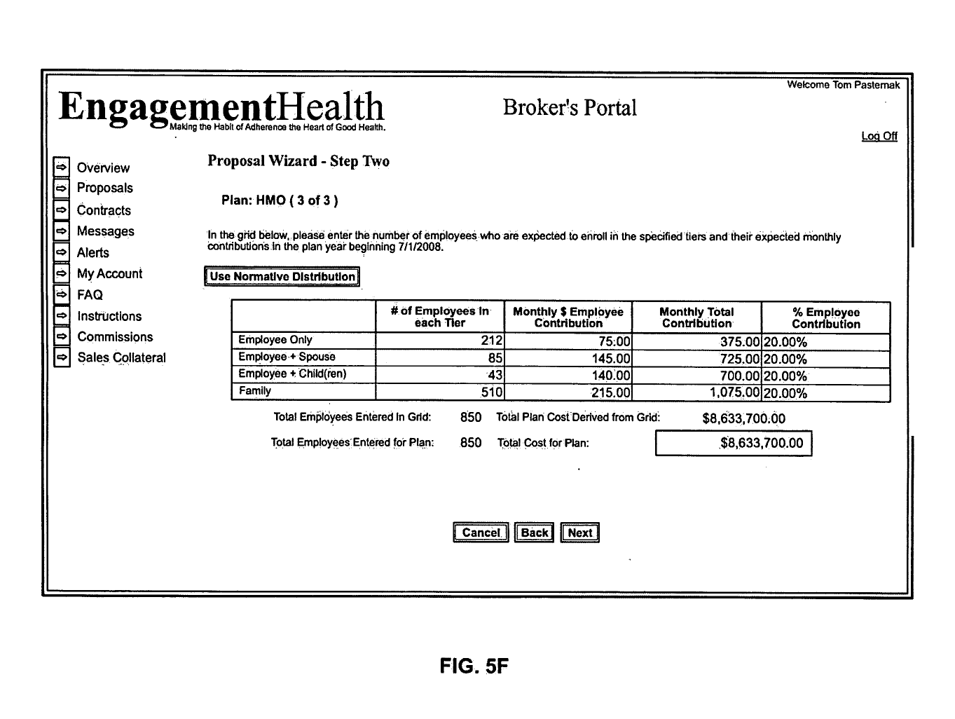

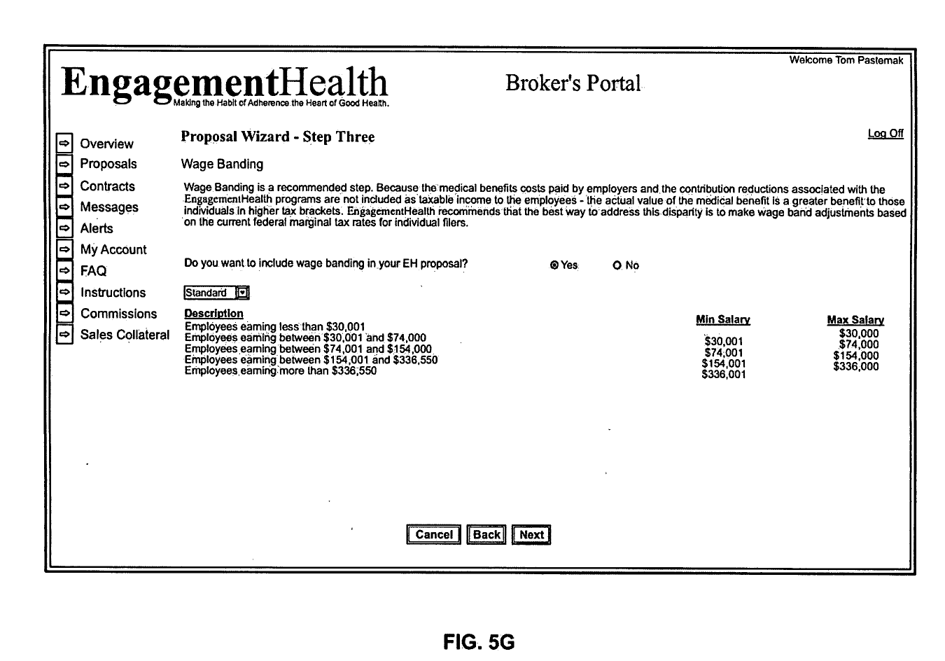

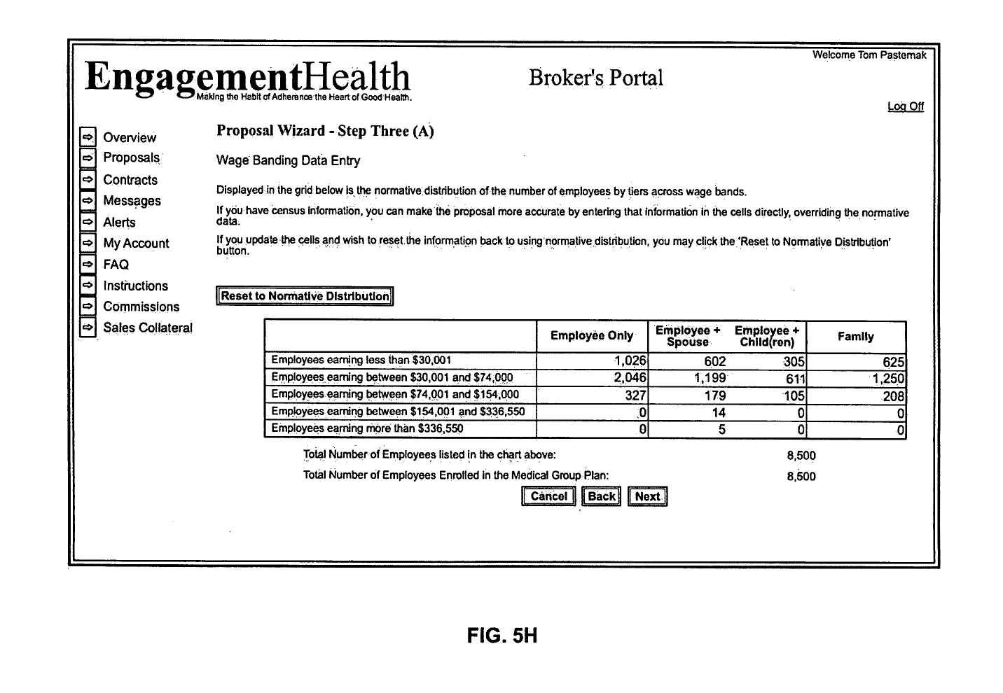

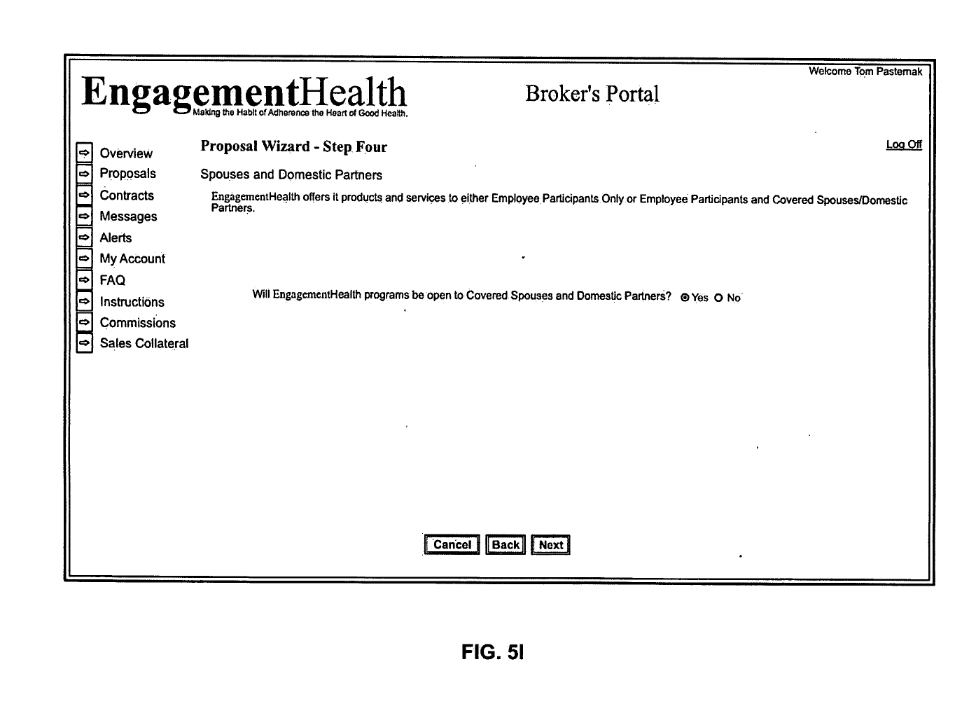

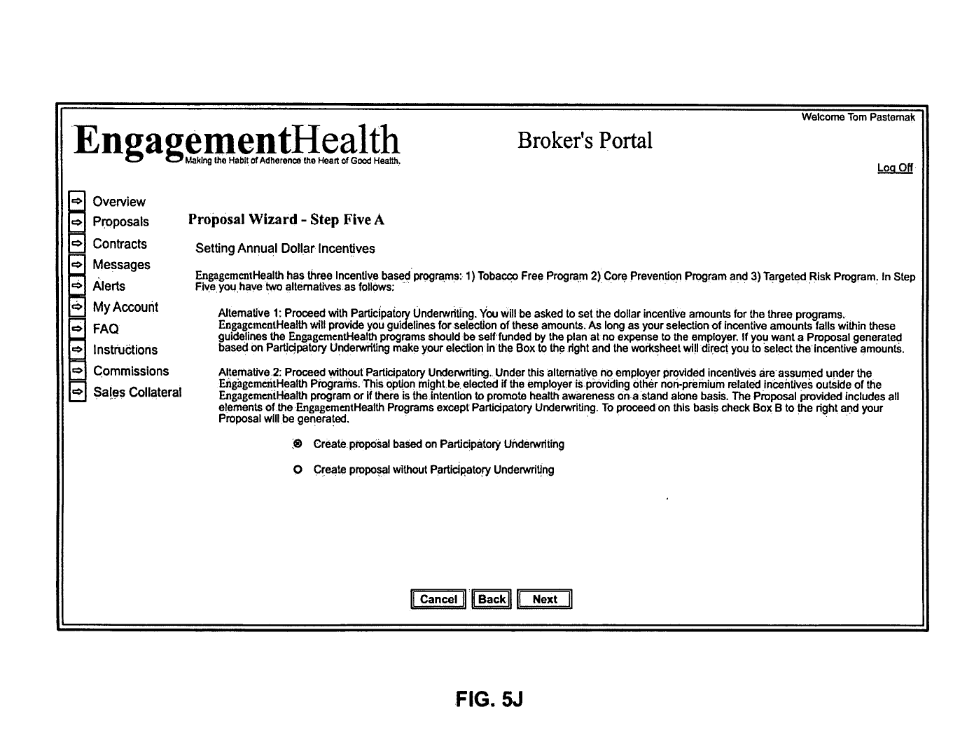

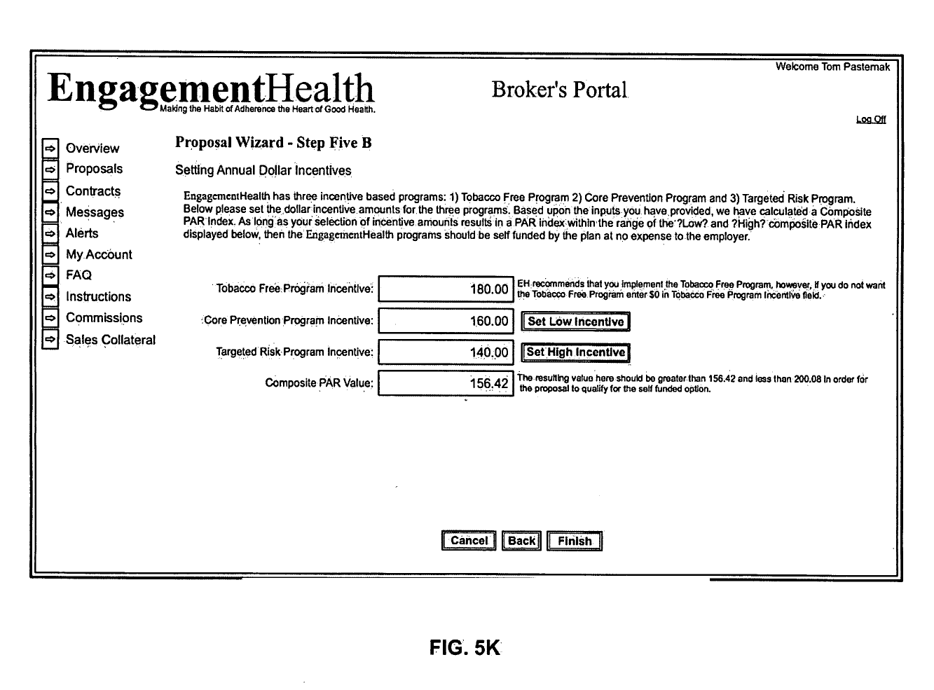

As a further illustrative example of an embodiment of further aspects of the present invention, a computer interface for a web based service offered to brokers and consultants who arrange for the placement of group health care coverage is shown in FIGS. 5A-5K. This “portal” is presently available to brokers who have registered with and who are selling the services of EngagementHealth LLC to their customers. The interface allows efficient implementation of the invention describe above.

It should be known the steps of the present invention maybe embodied in machine-executable instructions and that the instructions can be used to cause a general purpose or special purpose processor, which is programmed with instructions to perform the method. Alternatively, the method may be performed by specific hardware, components that contain hardwired logic for performing the steps, or by any combination of programmed computer components and custom hardware components.

Is should be further known that the present invention may be provided as a computer program product which may include a machine-readable medium having stored thereon instructions which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, or other type of media/machine-readable medium suitable for storing electronic instructions.

Moreover the present invention may also be downloaded as a computer product, wherein the program may be transferred from a remote computer (e.g., a server) to a requesting computer (e.g., a client) by way of data signals embodied in a carrier wave or other propagation medium via a communication link (e.g., a modem or network connection).

Further, while, embodiments of the present invention will be described with reference to a group health plans, the method and apparatus described herein are equally applicable to other types of underwriting or risk ratings applications in the and outside the areas of insurance.

While embodiments of the invention have been shown and described, it will be apparent to those skilled in the art that changes and modifications may be made therein without departing from the spirit of the invention.

I claim:

1. A method for setting members' premiums in a health insurance plan comprising the steps of:
determining an annual cost of said health insurance plan;
establishing health programs for said members in said health insurance plan and determining a cost for said health programs;
establishing by data collection and predictive modeling through use of a predictive model a relationship between an assigned financial incentive to a specific health program and the incentive's impact on member participation rates and adherence rates for the programs;
allocating some portion of said annual cost of said health plan among its members based on each members' participation in and adherence to said health programs; and
setting said members' contributions or premiums based on said allocation.

2. The method of claim 1 further comprising the step of providing an accrual to said annual cost that accounts for a cost of future claims for treatment of health conditions.

3. The method of claim 1 further comprising the step of dividing the members into a plurality of tiers based upon their relations to other dependents covered by insurance in said health plan.

4. The method of claim 3 further comprising the step of dividing said tiers into a plurality of bands based upon said members' income.

5. The method of claim 1 further wherein said monetary values for adherence are set such that said health programs are self-funded.

6. The method of claim 1 further comprising the step of optimizing participation in said health programs.

7. The method of claim 1 further comprising the step of periodically updating said predictive model.

8. A system for use in setting member's premiums in a health insurance plan for determining an annual cost of said health insurance plan, said system comprising:
means for establishing health programs for said members in said health insurance plan and determining a cost for said health programs;
means for establishing by data collection and predictive modeling through use of a predictive model the relationship between an assigned a financial incentive to a specific health program and the incentive's impact on member participation rates and adherence rates for the programs;
means for allocating some portion of said annual cost of said health plan among its members based on each members' participation inland adherence to said health programs; and
means for setting said members' contributions or premiums based on said allocation.

9. The system of claim 8 further comprising means for providing an accrual to said annual cost that accounts for a cost of future claims for treatment of health conditions.

10. The system of claim 8 further comprising means for dividing the members into a plurality of tiers based upon their relations to other dependents covered by insurance in said health plan.

11. The system of claim 10 further comprising means for dividing said tiers into a plurality of bands based upon said members' income.

12. The system of claim 8 further comprising means for setting said monetary values for adherence are to make sure health programs are self-funded.

13. The system of claim 8 further comprising means for optimizing participation in said health programs.

14. The method of claim 8 further company means for periodically updating said predictive model.

15. The system of claim 8 further comprising means for providing an accrual to said annual cost that accounts for the cost of future claims for the treatment of health conditions.

16. A user interface for use in setting members' premiums in a health insurance plan comprising display areas allowing users to:
determine an annual cost of said health insurance plan;
establish health programs for said members in said health insurance plan and determine a cost for said health programs;
establish by data collection and predictive modeling through use of a predictive model a relationship between an assigned a financial incentive to a specific health program and the incentive's impact on member participation rates and adherence rates for the programs;
allocate some portion of said annual cost of said health plan among its members based on each members' participation in and adherence to said health programs; and
set said members' contributions or premiums based on said allocation.

17. The interface of claim 16 further comprising display areas for users to provide an accrual to said annual cost that accounts for a cost of future claims for treatment of health conditions.

18. The interface of claim 16 further comprising display areas to allow user to divide the members into a plurality of tiers based upon their relations to other dependents covered by insurance in said health plan.

19. The interface of claim 18 further comprising display areas to allow users to divide said tiers into a plurality of bands based upon said members' income.

20. The interface of claim 16 further comprising display areas to allow users to set such monetary values for adherence such that said health programs are self-funded.
